(19) United States
(12) Patent Application Publication
(10) Pub. No.: US 2011/0026369 A1
(43) Pub. Date: Feb. 3, 2011

(54) Timepiece with Wireless Transmission Arrangement

(76) Inventor: Tai Wai LUK, Hong Kong (HK)

Correspondence Address: Tai Wai LUK;c/o IFF, 333 W. Garvey Avenue, #B, PMB 601, Monterey Park, CA, 91754, US

(21) Appl. No.: 12/512,992

(22) Filed: Jul. 31, 2009

(51) Int. Cl. G04C 11/02

(52) U.S. Cl. 368/47

(57) ABSTRACT

A timepiece includes a time displaying device, and a wireless transmission arrangement, which includes a first Main Control Unit (MCU), a wireless dongle and a primary transceiver device. The first MCU includes a first Central Processing Unit (CPU) core and a first memory unit arranged to implement a File Allocation Table (FAT) for managing memory data stored in the first memory unit. The wireless dongle is electrically connected to a computer. The primary transceiver device is electrically connected with the first MCU and wirelessly communicated with the wireless dongle, wherein the memory data is allowed to be wirelessly transmitted to the wireless dongle through the primary transceiver device so that the memory data originally stored within the first memory unit is capable of being processed in the computer, and addition data originally stored within the computer can be wirelessly transferred and stored in the first memory unit.

### BACKGROUND OF THE PRESENT INVENTION

1. Field of Invention

The present invention relates to a timepiece, and more particularly to a timepiece with a wireless transmission arrangement which is capable of facilitating data transmission between the timepiece and a computer.

1. Description of Related Arts

A conventional timepiece having memory function, such as a conventional watch having data storage function, typically includes a casing, a time display unit, a main control unit (MCU) provided in the casing for controlling the time display unit to indicate current time and/or date information. The MCU may comprise a central processing unit and a memory unit for storing predetermined types of data. With the advance of information technology, the memory unit of a conventional timepiece is capable of storing a relatively large amount of data and thereby facilitating a wide range of electronic functions. For example, a conventional timepiece may be able to store songs or phone numbers or address information so that a user is able to access the relevant information whenever he or she needs.

There are several inadequacies in association with this type of conventional timepiece. First, a user may need to manage or modify the data stored in the timepiece so as to keep the information up-to-date and accurate. Very often, the timepiece itself may provide mechanisms in which the user may modify the data stored therein. For example, the timepiece may comprise a plurality of input buttons and a small display for allowing the user to alter or modify the data stored therein through the control buttons. The disadvantage of this conventional method is that the display and the buttons may be too small so that when a user needs to extensively modify the data, the entire process would be very inconvenient or time-consuming.

Second, almost all timepieces with memory function do not allow the user to modify or edit the data by an external device, such as a computer, where bigger monitors or more convenient programs may be utilized for data management and modification. These conventional timepieces are incapable of establishing any sort of communication between the memory unit and the external device. In other words, users of conventional timepieces can only utilize highly inconvenient and time-consuming methods or procedures for achieving modification or editing of data stored in the conventional timepieces. More specifically, those conventional timepieces do not allow their users to wirelessly save or retrieve data into or from the timepieces directly by operating a computer. Since there is no electrical or wireless communication between a timepiece and a computer, a user cannot, for example, by clicking on his or her computer screen to save or retrieve data into and from that timepiece.

### SUMMARY OF THE PRESENT INVENTION

A main object of the present invention is to provide a timepiece comprising a wireless transmission arrangement which is capable of facilitating wireless data transmission between the timepiece and a computer, so that a user may be able modify, edit, save into or retrieve data from the timepiece through a computer.

Another object of the present invention is to provide a timepiece comprising a wireless transmission arrangement, wherein the electrical communication between the timepiece and the external electronic device such as the computer is accomplished through a wide variety of wireless signal transmission technologies.

Another object of the present invention is to provide a timepiece with a wireless transmission arrangement comprising a memory unit, wherein the memory unit can be embodied as a flash memory drive implementing a File Allocation Table (FAT) so that the data stored in the memory through the FAT can be wirelessly transmitted through a wireless transceiver device and a wireless dongle electrically and externally connected to or internally incorporated into a computer.

Another object of the present invention is to provide a timepiece with a wireless transmission arrangement which may be implemented in timepieces having one or more main control unit (MCU), so as to allow the wireless transmission arrangement to have a wide range of applications in different types of timepieces.

Another object of the present invention is to provide a timepiece with a wireless transmission arrangement, which can be partially implemented in a wireless transceiver module so that a conventional timepiece manufacturer may readily and conveniently implement the wireless transceiver to an existing conventional timepiece.

Another object of the present invention is to provide a wireless transmission arrangement for a personal accessory, such as an electronic device, which is capable of facilitating wireless data transmission between the personal accessory and a computer, so that data stored in the personal accessory can be modified or edited in the computer.

Accordingly, in order to accomplish the above objects, the present invention provides a timepiece, comprising:

a casing;

a time displaying device received in the casing to display time information; and

a wireless transmission arrangement, which comprises:

a first Main Control Unit (MCU) which is received in the casing, and comprises a first Central Processing Unit (CPU) core and a first memory unit having a first memory module electrically connected with the CPU core for storing a predetermined volume of memory data, wherein the first memory module is arranged to implement a File Allocation Table (FAT) for managing the memory data stored in the memory unit;

a wireless dongle arranged to electrically connect to a computer adapted for generating at least one standardized File Transfer Protocol (FTP) command, wherein the wireless dongle comprises a wireless dongle transceiver for wirelessly transmitting and receiving information which includes at least the FTP command; and

a primary transceiver device electrically connected with the first main control unit and wirelessly communicated with the wireless dongle, wherein when the primary transceiver device receives the FTP command through wireless transmission from the wireless dongle, the FTP command is electrically transmitted to the first MCU which is arranged to execute the FTP command by sending a corresponding FAT information to the computer wirelessly through the primary transceiver device and the wireless dongle, so as to allow the memory data originally stored within the first memory unit to be recognized and processed in the computer, wherein additional data originally stored within the computer is adapted to be wirelessly transferred and stored in the first memory unit as the memory data through the primary transceiver device and the wireless dongle.

### BRIEF DESCRIPTION OF THE DRAWINGS

FIG. 1A and FIG. 1B are schematic diagrams of a timepiece having a wireless transmission arrangement according to a preferred embodiment of the present invention.

FIG. 2A and FIG. 2B are schematic diagrams of the interaction between the wireless transmission arrangement, the timepiece and a computer according to a preferred embodiment of the present invention.

FIG. 3A and FIG. 3B are alternative mode of the timepiece having a wireless transmission arrangement according to a preferred embodiment of the present invention.

### DETAILED DESCRIPTION OF THE PREFERRED EMBODIMENT

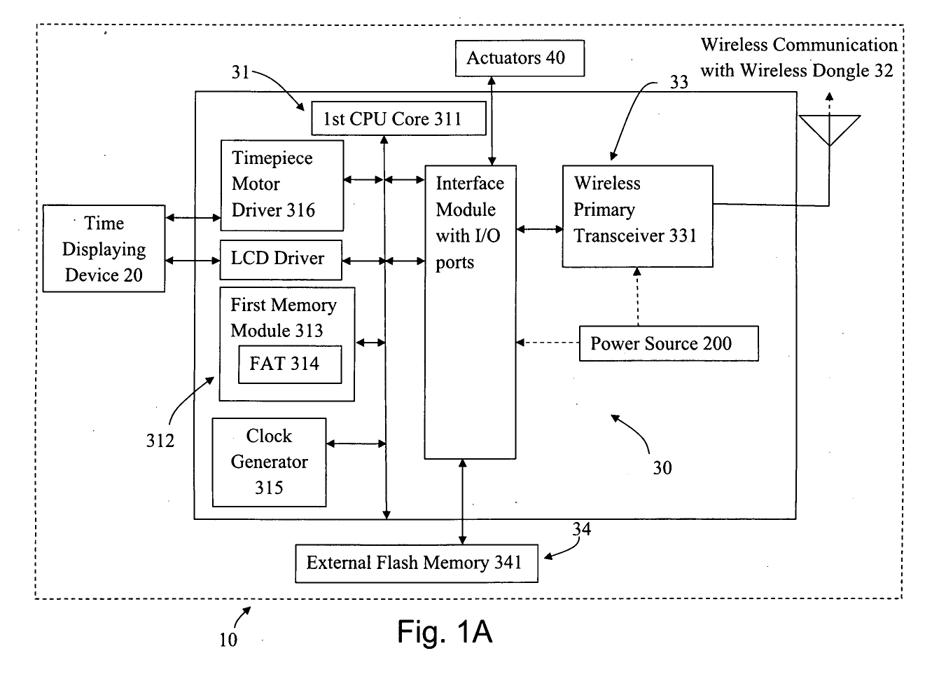

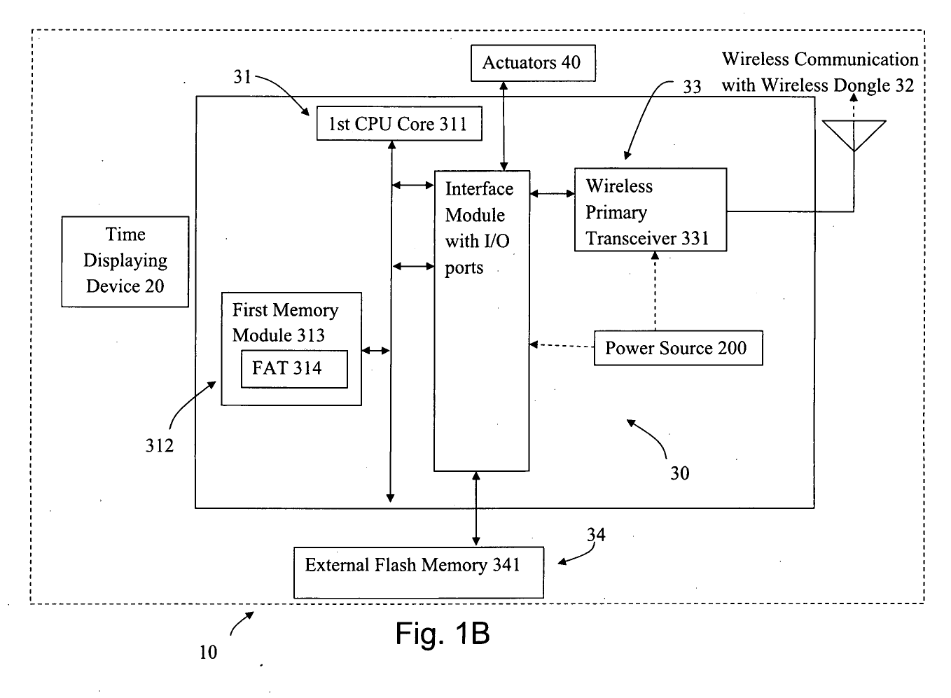

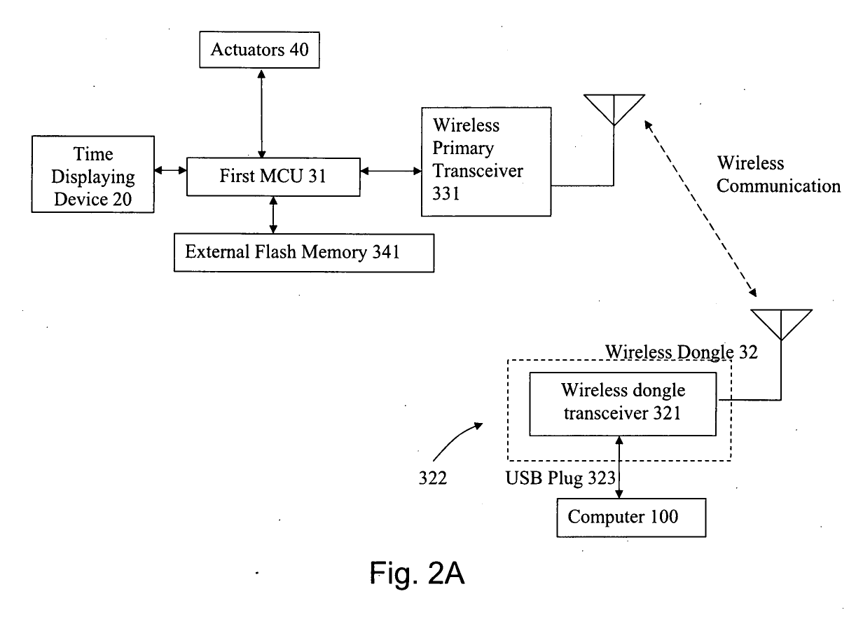

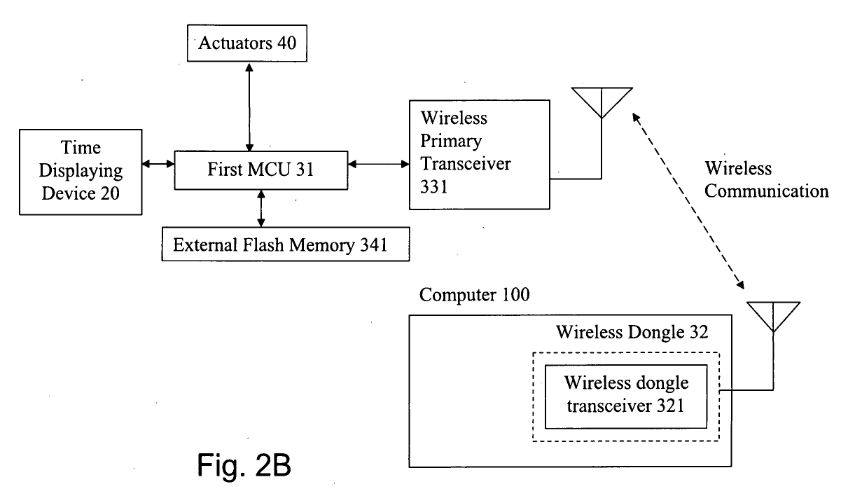

Referring to FIG. 1A, FIG. 1B, FIG. 2A and FIG. 2B of the drawings, a timepiece for use in conjunction with a computer 100 according to a preferred embodiment of the present invention is illustrated. The timepiece comprises a casing 10, a time displaying device 20, and a wireless transmission arrangement 30. The casing 10 is a typical casing for a typical timepiece, such as a casing for a watch or a casing for a clock. It can be made by many materials, such as plastic or metal, or composites materials. The computer 100 is adapted to generate a standard File Transfer Protocol (FTP) command which is wirelessly transmitted by the wireless transmission arrangement 30.

The time displaying device 20 is received in the casing 10 to display time information and/or date information. The time displaying device 20 is a conventional time displaying device and may comprise a plurality of indicating hands, calendar discs or a small LCD display for indicating time and/or date information.

The wireless transmission arrangement 30 comprises a first Main Control Unit (MCU) 31, a wireless dongle 32, and a primary transceiver device 33. The first MCU 31 is received in the casing 10, and comprises a first Central Processing Unit (CPU) core 311 and a first memory unit 312 having a first memory module 313 electrically connected with the first CPU core 311 for storing a predetermined volume of memory data, wherein the first memory module 313 is arranged to implement a File Allocation Table (FAT) 314 for managing the memory data stored in the first memory unit 312.

The wireless dongle 32 is adapted for electrically connected to a computer 100, and comprises a wireless dongle transceiver 321 for wirelessly transmitting and receiving information.

The primary transceiver device 33 is electrically connected with the first main control unit (MCU) 31 and wirelessly communicated with the wireless dongle 32, wherein the memory data is allowed to be wirelessly transmitted to the wireless dongle 32 through the primary transceiver device 33, and that the memory data originally stored within the first memory unit 312 is capable of being processed in the computer 100. Additional data originally stored within the computer 100 is also adapted to be wirelessly transferred and stored in the first memory unit 312 as the memory data through the primary transceiver device 33 and the wireless dongle 32.

More specifically, the primary transceiver device 33 is electrically connected with first MCU 31 and wirelessly communicated with the wireless dongle 32, wherein the memory data stored in the first memory unit 312 is allowed to be wirelessly managed by the computer 100 through wireless data transmission between the wireless dongle 32 and the primary transceiver device 33 so that the memory data originally stored within the first memory unit 312 is capable of being processed in the computer 100, and additional data originally stored within the computer 100 is adapted to be wirelessly transferred and stored in the first memory unit 312 as the memory data through the primary transceiver device 33 and the wireless dongle 32. Moreover, the first MCU 31 also controls the operation of the primary transceiver device 33. The wireless signal transmission between the primary transceiver device 33 and the wireless dongle 32 is preferably Bluetooth transmission. Other types of wireless transmissions, such as radio frequency (RF) transmission, are also possible.

According to the preferred embodiment of the present invention, the time displaying device 20 can be electrically connected with the wireless transmission arrangement 30 (FIG. 1A) so that the MCU 31 also manages the displaying of time and date information. Alternatively, the time displaying device 20 can be a self-operating unit and the time displaying operation of the time displaying device 20 is independent from the operation of the wireless transmission arrangement 30 or the first MCU 31 (FIG. 1B). In both situations, however, the wireless transmission arrangement 30 and the time displaying device 20 are both received in the casing 10 so as to constitute a self-operating timepiece, such as a watch or a clock. Note also that the time displaying device 20 can be an analog type time displaying device 20 displaying time and date information by the indicating hands and/or the calendar discs, or a digital type time displaying device 20 displaying time and date information by LCD, or a combination of both.

Therefore, there are two alternative arrangements between the first MCU 31 and the time displaying device 20 in the timepiece according to the preferred embodiment of the present invention. Referring to FIG. 1A of the drawings, the first MCU 31 is electrically connected to the time displaying device 20 so that the operation of the time displaying device 20 is also controlled and managed by the first MCU 31. The advantage of this arrangement is that a single first MCU 31 can be pre-programmed to control all of the operational aspects of the timepiece. For example, the first MCU 31 can be used to control the time displaying device 20 and the primary transceiver device 33. In this sense, the necessary components leading to time displaying, such as motors, time indicating hands and LCD screen(s), are also controlled by the first MCU 31.

Alternatively, referring to FIG. 1B of the drawings, the time displaying device 20 and the first MCU 31 has no electrical connection so that the time displaying device 20 works on its own to display time and date information. However, both the time displaying 20 and the first MCU 31 and the primary transceiver device 33 are received in the casing 10 so that the entire timepiece can be conveniently used with both time displaying function and data transfer function. This also allows manufacturers of the present invention to seek different manufacturers for manufacturing different components of the timepiece of the present invention. For this version of the preferred embodiment, therefore, the first MCU 31 merely control the data transfer aspect of the timepiece while the time displaying aspect of the timepiece is run entirely by the time displaying device 20, which, as mentioned earlier, may be a conventional analog or electronic time displaying device 20.

According to the preferred embodiment of the present invention, the electrical communication between the first MCU 31 and the primary transceiver device 33 and between the primary transceiver device 33 and the wireless dongle 32 are accomplished through Object Exchange (OBEX) communication protocol incorporated in Bluetooth communication technology when wireless data transmission is performed.

The first memory unit 312 is embodied as a flash memory (which can be an internal flash memory or Random Access Memory (RAM)) arranged to implement standardized File Transfer Protocol (FTP) profile in the first memory module 313, so that data can be saved, retrieved or deleted in the first memory module 313 by using the standardized FTP profile and the relevant commands. Since the first memory module 313 is arranged to utilize FAT as computer file system architecture, the memory data stored and managed in the first memory module 313 can be readily recognizable by the computer 100 when the relevant information is wirelessly transmitted to the computer 100.

As shown in FIG. 2A of the drawings, the wireless dongle 32 further comprises a dongle casing 322 and a USB plug 323 provided on the dongle casing 322 for selectively inserting into a standard USB socket of the computer 100 so as to facilitate data transmission between the wireless dongle 32 and the computer 100. In other words, memory data stored in the first MCU 31 or the relevant information thereof can be wirelessly transmitted to the computer 100 through the wireless dongle 32 and USB data transmission between the wireless dongle 32 and the computer 100.

Alternatively (as shown in FIG. 2B of the drawings), the wireless dongle 32 can also be pre-installed within the computer 100 so that a user needs not plug the dongle casing 322 to the USB socket of the computer 100 every time he or she wishes to transfer or manage data between the timepiece and the computer 100. One disadvantage of this, though, is that a user cannot selectively pick which computer 100 he or she wishes to use once the wireless dongle 32 has been pre-installed into a particular computer 100. However, these two alternatives of the wireless dongle 32 are clearly different alternatives of the preferred embodiment of the present invention. The decision as to which version of the alternatives is to be used in actual production depends on the circumstances of particular marketing strategies.

When the first MCU 31 also controls the time displaying device 20 (FIG. 1A), the first MCU 31 will further comprise a clock generator 315 for providing time signal to the time displaying device 20, and a timepiece motor driver 316 for the diving time displaying device 20. However, if the time displaying device 20 works on its own to provide time and date information (FIG. 1B), the clock generator 315 and the timepiece motor driver 316 can be omitted from the first MCU 31.

The primary transceiver device 33 comprises a wireless primary transceiver 331 received in the casing 10 and electrically connected to the first MCU 31 and wirelessly communicating with the wireless dongle 32. Both the first MCU 31 and the primary transceiver device 33 are powered by a power source 200, which is preferably also received in the casing 10. The power source 200 can be a battery.

In order to further expand the storage capacity and flexibility of the timepiece, the wireless transmission arrangement 30 further comprises an external flash memory 34 selectively connected to the casing 10 so as to electrically and selectively connect to the first MCU 31. The flash memory 34 comprises a flash memory module 341 which is identical to that of the first memory unit 312 except that the external flash memory 34 can be externally added on to the casing 10. In other words, the flash memory module 341 is also arranged to implement standardized File Transfer Protocol (FTP) profile, so that data can be saved, retrieved or deleted in the flash memory module 341 by using the standardized FTP profile. Moreover, the flash memory module 341 is also arranged to utilize FAT as computer file system architecture, so that the memory data stored and managed in the flash memory module 341 can also be readily processed by the computer 100.

In other words, the first MCU 31 has the function of using standardized FTP to communicate with the wireless dongle 32, controlling the operation of the primary transceiver device 33, maintaining the FAT within the first memory unit 312, executing file management according to FTP commands, and controlling the time displaying device 20 if it is connected to the first MCU 31.

Finally, the casing 10 further comprises a plurality of actuators 40 provided thereon for allowing the user to control the operation of the wireless transmission arrangement 30 by actuating the actuators 40.

When the computer 100 needs to edit a data file in the first memory unit 312 of the timepiece, the computer 100 is arranged to send out a FTP command as an electrical signal to the wireless dongle 32 which is then transmitted wirelessly by the wireless dongle transceiver 321 to the wireless primary transceiver 331 of the primary transceiver device 33 through Bluetooth technology and OBEX protocol. Upon receipt of this wireless electrical signal from the computer 100 and the wireless dongle 32, the wireless primary transceiver 331 is arranged to transmit the FTP command to the first MCU 31 through one of its I/O ports. The first CPU core 311 will then interpret this FTP command and execute this command (such as change of folder's name).

For instances, if a data file (i.e. the memory data) is needed to be edited in the first memory unit 312, the first CPU core 311 executes the edit command and then the relevant file is edited in the first memory unit 312 as cluster, and the location of that cluster is recorded in the FAT so that the system knows where the file is edited in the first memory module 313. This mechanism is also used for other types of editing, such as writing or deleting data stored in the first memory unit 312. When a file is to be transferred to the timepiece from the computer 100, the relevant file will be wirelessly transmitted by the wireless dongle 32 to the primary transceiver device 33 via the OBEX communication protocol. The relevant data is received by the primary transceiver device 33 and electrically transmitted to the first MCU 31 through a predetermined protocol.

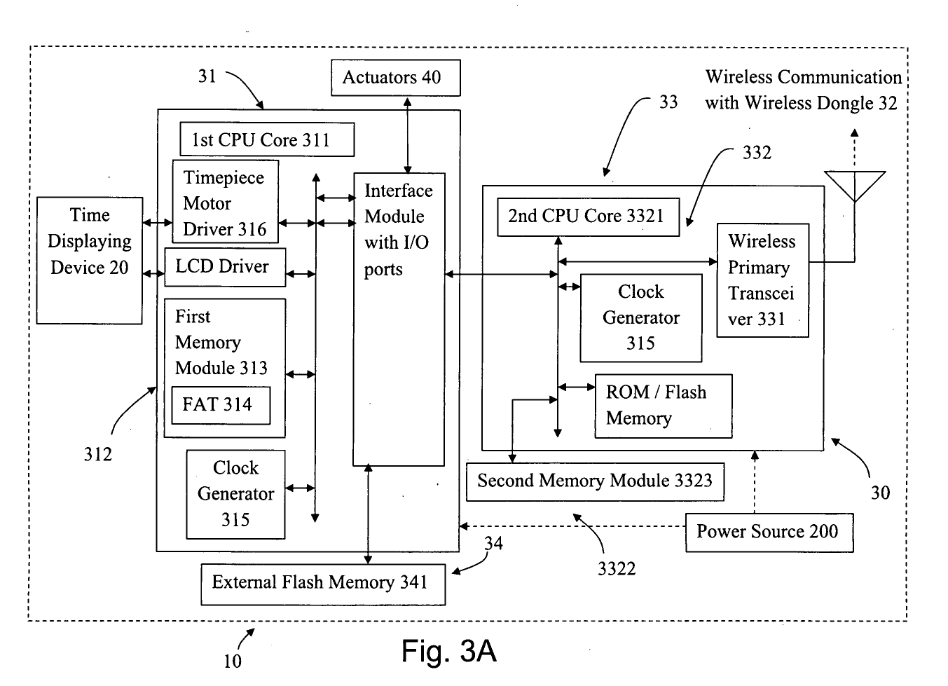

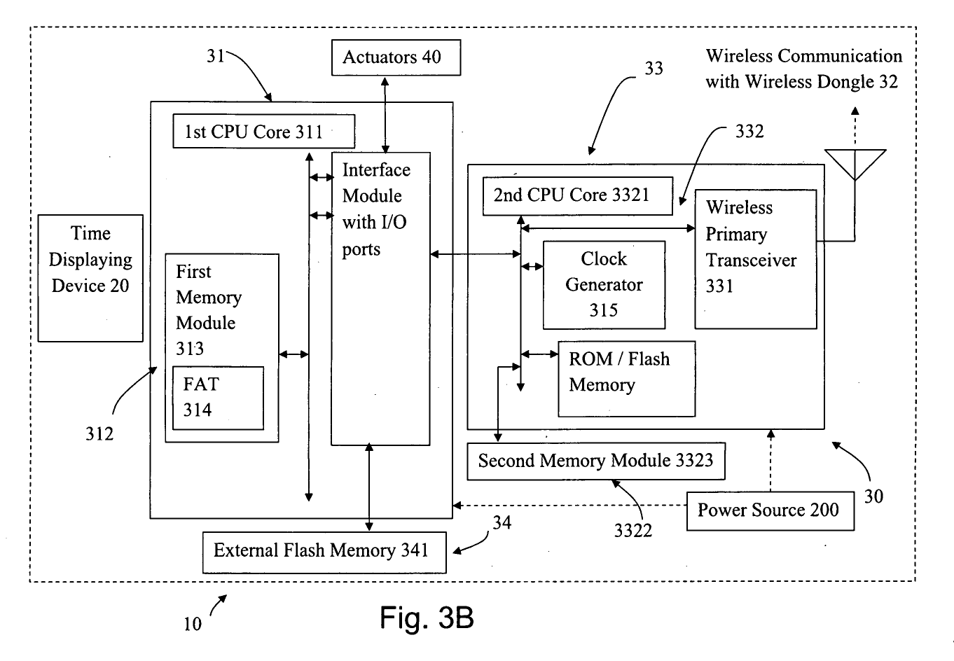

Referring to FIG. 3A and FIG. 3B of the drawings, an alternative mode of the timepiece according to the preferred embodiment of the present invention is demonstrated. In this alternative mode, the primary transceiver device 33 further comprises a second Main Control Unit (MCU) 332 which is arranged to electrically connect with the first MCU 31, such that the first and the second MCU 31, 332 are arranged to control different components within the timepiece of the present invention.

The second MCU 332 comprises a second CPU core 3321 and a second memory unit 3322 having a second memory module 3323 electrically connected with the second CPU core 3321 for storing a predetermined volume of memory data. As shown in FIG. 3A of the drawings, the first MCU 31 is electrically connected to the time displaying device 20 for controlling an operation thereof, and the second MCU 332 is electrically connected to the wireless primary transceiver 331.

The second MCU 332 is arranged to have the functions of using standardized FTP to communicate with the wireless dongle 32, controlling an operation of the wireless primary transceiver 331, and communicating with the first MCU 31 according to a predetermined protocol which is interpreted from the FTP commands given by the computer 100. As a result, the first MCU 31 has the functions of maintaining a FAT in the first memory unit 312, executing file management according to the command received from the second MCU 332 according to the predetermined protocol (such as the OBEX communication protocol) that is set up between these two MCU 31, 332, and controlling the time displaying device 20 if the first MCU 31 is arranged to control an operation of the time displaying device 20.

As shown in FIG. 3A, the first MCU 31 is responsible for controlling the operation of the time displaying device 20. As such, there exist a clock generator 315 and a timepiece motor driver 316 provided in the first MCU 31. However, as mentioned earlier, if the first MCU 31 does not control the time displaying device 20 (i.e. the time displaying device 20 works on its own), the clock generator 315 and the timepiece motor driver 316 can then be omitted, as shown in FIG. 3B of the drawings.

It is worth mentioning that the reason of having two separate MCUs 31, 332 is that the primary transceiver device 33 and the first MCU 31 (which can be implemented to a conventional timepiece) can be separately manufactured according to different marketing strategies.

In this alternative mode, when the computer 100 needs to edit a data file in the first memory unit 312 of the timepiece, the computer 100 is arranged to send out a FTP command as an electrical signal to the wireless dongle 32 which is then transmitted wirelessly by the wireless dongle transceiver 321 to the wireless primary transceiver 331 of the primary transceiver device 33 (preferably in a serial manner). Upon receipt of this wireless electrical signal from the computer 100, the wireless primary transceiver 331 is then arranged to transmit the commands according to the predetermined protocol (such as the OBEX communication protocol) to the first MCU 31. The first CPU core 311 will then interpret these commands for execution.

The corresponding FAT information is then transmitted back to the wireless primary transceiver 331 and is wirelessly sent back to the wireless dongle 32 and the computer 100. Then the computer 100 is arranged to interpret this FAT information and therefore is capable of reading or editing data contained in the first memory unit 312. Communications between the relevant components of the timepiece are preferably by means of OBEX communication protocol.

Similarly, if a data file is needed to be edited in the first memory unit 312, the first CPU core 311 executes the edit command and then the relevant file is edited in the first memory unit 312 as cluster, and the location of that cluster is recorded in the FAT so that the system knows where the file is edited in the first memory module 313. This mechanism is also used for other types of editing, such as writing or deleting data stored in the first memory unit 312. When a file is to be transferred to the timepiece from the computer 100, the relevant file will be wirelessly transmitted by the wireless dongle 32 to the primary transceiver device 33 via the OBEX communication protocol. The relevant data is then received by the primary transceiver device 33 and electrically transmitted to the first MCU 31 through a predetermined protocol.

From the above description, it can be appreciated that the wireless transmission arrangement 30 can be used in a wide variety of personal accessories or portable electronic devices, or any kind of timepieces so as to facilitate data transfer between the personal accessories, portable electronic devices or the timepiece. Thus, personal accessories having the wireless transmission arrangement 30 are also covered within the scope of this patent application.

Finally, it must be emphasized that the embodiment and alternatives of the present invention as shown in the drawings and described above are examples only and not intended to be limiting. Therefore, this invention includes all modifications envisaged within the spirit and scope of the claims that follow.

What is claimed is:

1. A timepiece, comprising:
a casing;
a time displaying device received in said casing to display time information; and
a wireless transmission arrangement, which comprises:
a first Main Control Unit (MCU) which is received in said casing, and comprises a first Central Processing Unit (CPU) core and a first memory unit having a first memory module electrically connected with said CPU core for storing a predetermined volume of memory data, wherein said first memory module is arranged to implement a File Allocation Table (FAT) for managing said memory data stored in said first memory unit;
a wireless dongle which is arranged to electrically connect to a computer, and comprises a wireless dongle transceiver for wirelessly transmitting and receiving information; and
a primary transceiver device electrically connected with said first main control unit and wirelessly communicated with said wireless dongle, wherein said memory data is allowed to be wirelessly transmitted to said wireless dongle through said primary transceiver device so that said memory data originally stored within said first memory unit is capable of being processed in said computer, and additional data originally stored within said computer is adapted to be wirelessly transferred and store in said first memory unit as said memory data through said primary transceiver device and said wireless dongle.

2. The timepiece, as recited in claim 1, wherein said first memory unit comprises a flash memory arranged to implement standardized File Transfer Protocol (FTP) profile in said first memory module, so that data is capable of being saved, retrieved or deleted in said first memory module by using said standardized FTP profile.

3. The timepiece, as recited in claim 2, wherein said wireless dongle further comprises a dongle casing and a USB plug provided on said dongle casing for selectively inserting into a standard USB socket of said computer so as to facilitate data transmission between said wireless dongle and said computer, wherein said memory data stored in said first MCU is capable of being wirelessly transmitted to said computer or vice versa through said wireless dongle and said USB data transmission between said wireless dongle and said computer.

4. The timepiece, as recited in claim 2, wherein said wireless dongle is pre-installed within said computer so that a user needs not externally connect said wireless dongle to said computer.

5. The timepiece, as recited in claim 3, wherein said primary transceiver device comprises a wireless primary transceiver received in said casing and electrically connected to said first MCU for wirelessly communicating with said wireless dongle, wherein said computer is arranged to send out a FTP command to said wireless dongle, which wirelessly transmits said FTP command to said primary transceiver device, wherein said primary transceiver device is arranged to transmit said FTP command to said first CPU core which is arranged to interpret said FTP command for execution in said first memory unit.

6. The timepiece, as recited in claim 4, wherein said primary transceiver device comprises a wireless primary transceiver received in said casing and electrically connected to said first MCU for wirelessly communicating with said wireless dongle, wherein said computer is arranged to send out a FTP command to said wireless dongle, which wirelessly transmits said FTP command to said primary transceiver device, wherein said primary transceiver device is arranged to transmit said FTP command to said first CPU core which is arranged to interpret said FTP command for execution in said first memory unit.

7. The timepiece, as recited in claim 5, wherein said time displaying device is electrically connected with said wireless transmission arrangement so that said first MCU is arranged to manage and control an operation of said time displaying device.

8. The timepiece, as recited in claim 6, wherein said time displaying device is electrically connected with said wireless transmission arrangement so that said first MCU is arranged to manage and control an operation of said time displaying device.

9. The timepiece, as recited in claim 5, wherein said time displaying device is a self-operating unit and is independent from said first MCU for displaying at least one of time information and date information.

10. The timepiece, as recited in claim 6, wherein said time displaying device is a self-operating unit and is independent from said first MCU for displaying at least one of time information and date information.

11. The timepiece, as recited in claim 3, wherein said primary transceiver device comprises a wireless primary transceiver and a second MCU which is arranged to electrically connect with said first MCU for wirelessly communicating with said wireless dongle, such that said first and said second MCU are arranged to control different components within said timepiece.

12. The timepiece, as recited in claim 4, wherein said primary transceiver device comprises a wireless primary transceiver and a second MCU which is arranged to electrically connect with said first MCU for wirelessly communicating with said wireless dongle, such that said first and said second MCU are arranged to control different components within said timepiece.

13. The timepiece, as recited in claim 11, wherein said second MCU comprises a second CPU core and a second memory unit having a second memory module electrically connected with said second CPU core for storing a predetermined volume of memory data, wherein said first MCU is electrically connected to said time displaying device for controlling an operation thereof, and said second MCU is electrically connected to said wireless primary transceiver for controlling an operation thereof.

14. The timepiece, as recited in claim 12, wherein said second MCU comprises a second CPU core and a second memory unit having a second memory module electrically connected with said second CPU core for storing a predetermined volume of memory data, wherein said first MCU is electrically connected to said time displaying device for controlling an operation thereof, and said second MCU is electrically connected to said wireless primary transceiver for controlling an operation thereof.

15. The timepiece, as recited in claim 11, wherein said second MCU comprises a second CPU core and a second memory unit having a second memory module electrically connected with said second CPU core for storing a predetermined volume of memory data, wherein said second MCU is electrically connected to said wireless primary transceiver for controlling an operation thereof.

16. The timepiece, as recited in claim 12, wherein said second MCU comprises a second CPU core and a second memory unit having a second memory module electrically connected with said second CPU core for storing a predetermined volume of memory data, wherein said second MCU is electrically connected to said wireless primary transceiver for controlling an operation thereof.

17. The timepiece, as recited in claim 8, wherein said wireless transmission arrangement further comprises an external flash memory selectively and externally connected to said casing so as to electrically and selectively connect to said first MCU, wherein said external flash memory comprises a flash memory module which is identical to said first memory unit, wherein said data stored in said external flash memory unit is also capable of being processed through FTP commands and being wirelessly transmitted through said wireless dongle and said primary transceiver device.

18. The timepiece, as recited in claim 10, wherein said wireless transmission arrangement further comprises an external flash memory selectively and externally connected to said casing so as to electrically and selectively connect to said first MCU, wherein said external flash memory comprises a flash memory module which is identical to said first memory unit, wherein said data stored in said external flash memory unit is also capable of being processed through FTP commands and being wirelessly transmitted through said wireless dongle and said primary transceiver device.

19. A wireless transmission arrangement for a personal accessory having a casing, comprising:
a first Main Control Unit (MCU) which is received in said casing, and comprises a first Central Processing Unit (CPU) core and a first memory unit having a first memory module electrically connected with said CPU core for storing a predetermined volume of memory data, wherein said first memory module is arranged to implement a File Allocation Table (FAT) for managing said memory data stored in said memory unit;
a wireless dongle adapted for electrically connected to a computer, wherein said wireless dongle comprises a wireless dongle transceiver for wirelessly transmitting and receiving information; and
a primary transceiver device electrically connected with said first main control unit and wirelessly communicated with said wireless dongle, wherein said memory data is allowed to wirelessly transmit to said wireless dongle through said primary transceiver device so that said memory data originally stored within said first memory unit is capable of being processed in said computer, and data originally stored within said computer is adapted to be wirelessly transferred and stored in said first memory unit as said memory data through said primary transceiver device and said wireless dongle.

20. The wireless transmission arrangement, as recited in claim 19, wherein said first memory unit comprises a flash memory arranged to implement standardized File Transfer Protocol (FTP) profile in said first memory module, so that data is capable of being saved, retrieved or deleted in said first memory module by using said standardized FTP profile.

21. The wireless transmission arrangement, as recited in claim 20, wherein said wireless dongle further comprises a dongle casing and a USB plug provided on said dongle casing for selectively inserting into a standard USB socket of said computer so as to facilitate data transmission between said wireless dongle and said computer, so that said memory data stored in said first MCU is capable of being wirelessly transmitted to said computer or vice versa through said wireless dongle and said USB data transmission between said wireless dongle and said computer.

22. The wireless transmission arrangement, as recited in claim 20, wherein said wireless dongle is pre-installed within said computer so that a user needs not externally connect said wireless dongle to said computer.

23. The wireless transmission arrangement, as recited in claim 23, wherein said primary transceiver device comprises a wireless primary transceiver and a second MCU which is arranged to electrically connect with said first MCU for wirelessly communicating with said wireless dongle, such that said first and said second MCU are arranged to control different components within said personal accessory.

24. The wireless transmission arrangement, as recited in claim 22, wherein said primary transceiver device comprises a wireless primary transceiver and a second MCU which is arranged to electrically connect with said first MCU for wirelessly communicating with said wireless dongle, such that said first and said second MCU are arranged to control different components within said personal accessory.

25. The wireless transmission arrangement, as recited in claim 23, wherein said second MCU comprises a second CPU core and a second memory unit having a second memory module electrically connected with said second CPU core for storing a predetermined volume of memory data, wherein said second MCU is electrically connected to said wireless primary transceiver for controlling an operation thereof.

26. The wireless transmission arrangement, as recited in claim 24, wherein said second MCU comprises a second CPU core and a second memory unit having a second memory module electrically connected with said second CPU core for storing a predetermined volume of memory data, wherein said second MCU is electrically connected to said wireless primary transceiver for controlling an operation thereof.
